(19) United States
(12) Patent Application Publication
(10) Pub. No.: US 2023/0288379 A1
(43) Pub. Date: Sep. 14, 2023

(54) SYSTEM AND METHOD FOR MONITORING HEAT TRANSFER EQUIPMENT

(71) Applicant: TZero Research & Development LLC, State College, PA (US)

(72) Inventors: Stephen M. Wells, State College, PA (US); Nicholas A. Wells, State College, PA (US); Eli M. Hughes, State College, PA (US)

(21) Appl. No.: 18/180,471

(22) Filed: Mar. 8, 2023

Related U.S. Application Data
(60) Provisional application No. 63/379,817, filed on Oct. 17, 2022.
(60) Provisional application No. 63/268,979, filed on Mar. 8, 2022.

(51) Int. Cl. G01N 29/32; G01N 17/00; G01N 29/04; G01N 25/18

(52) U.S. Cl. CPC G01N 29/326; G01N 17/008; G01N 29/04; G01N 25/18

(57) ABSTRACT

A system monitors temperature and vibration of one or more conduits that are part of a fluid flow path or paths of heat transfer equipment to detect potential fouling or other maintenance issues within the fluid flow path(s).

### RELATED APPLICATIONS AND CLAIM OF PRIORITY

This application claims the benefit of U.S. Provisional Application No. 63/268,979, filed Mar. 8, 2022; and U.S. Provisional Application No. 63/379,817, filed Oct. 17, 2022, the disclosures of which are each fully incorporated into this document by reference.

### BACKGROUND

Heat transfer equipment is used in many commercial and industrial processes. Heat transfer equipment is any device or system that transfers heat from a one medium to another medium (i.e., from a relatively cold medium to a relatively hot medium, or vice versa). Examples of heat transfer equipment include heaters, heat exchangers, water and air coolers, condensers, pasteurization equipment, reboilers, and heat exchanger coils. In such equipment, the heat transfer medium is often a fluid, as is the case in plate heat exchangers, frame heat exchangers, shell and tube heat exchangers, condensers, and reboilers. The fluid is carried into and through the equipment via a system of pipes. Over time, dirt, scale, algae, corrosion, pitting and other materials and conditions may build on the pipes' interior walls.

These fouling factors can reduce the fluid flow rate, and therefore reduce the equipment's heating and cooling capabilities and/or efficiency. Over time, these factors can cause the equipment to fail. Fouling can also occur in other types of equipment that carry fluids, such as pumps and compressors. Therefore, detection of such fouling of the fluid piping within heat exchangers, other heat transfer equipment, and other fluid-carrying equipment is an important problem.

Current heat exchanger equipment monitoring systems typically use flow and/or pressure meters to detect fouling in the equipment. When the system detects that the flow rate or pressure of fluid into or out of the heat exchanger drops, it may signal that the heat exchanger should be tested for potential fouling. However, flow rate meters and pressure meters are expensive and must be placed within the heat exchanger fluid flow path. Such meters often require maintenance themselves, and the equipment's piping often needs to be modified to accept the meters. Further, such meters only detect maintenance issues after fouling has built up to a fairly significant extent, and in such cases the equipment will have operated inefficiently until the monitor detects an issue, which can be a significant period of time.

This document describes a method and system that solves at least some of the problems described above.

### SUMMARY

This document describes systems and methods that use one or more sensors to monitor temperature and vibration of one or more conduits, each of which is part of a fluid flow path of heat transfer or other fluid-carrying equipment. The system uses the monitored parameters, along with characteristics of the fluid or fluids within each fluid flow path, to detect potential fouling within the fluid flow path(s) and/or other maintenance issues.

### BRIEF DESCRIPTION OF THE DRAWINGS

FIG. 1 illustrates elements of an example system for measuring characteristics of a heat transfer system.

FIG. 2 illustrates elements of a first embodiment of a sensor device that is configured to monitor equipment such as that shown in the system of FIG. 1.

FIGS. 3A and 3B illustrate example electronic components that a circuit board of the sensor device of FIG. 2 may include.

FIGS. 4A and 4B illustrate an example sensor device secured to a conduit and connected to an external power source, respectively.

FIG. 5 is a flowchart illustrating an example process by which a system may monitor various characteristics of heat transfer equipment to detect the presence of fouling within a fluid flow path of the heat transfer equipment.

FIG. 6 is a flowchart illustrating an example process by which a system may use multiple sensors to monitor multiple flow paths within heat transfer equipment to detect the presence of fouling within any of the fluid flow paths.

FIG. 7 illustrates example electronic components that may be used in various aspects.

FIG. 8 illustrates elements of a second embodiment of a sensor device that is configured to monitor equipment such as that in the system of FIG. 1.

FIG. 9 illustrates an example report that the systems and methods described above may generate, showing efficiency of a heat exchanger dropping over time.

### DETAILED DESCRIPTION

As used in this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” (or “comprises”) means “including (or includes), but not limited to.”

In this document, when terms such “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

When used in this document, terms such as “top” and “bottom,” “upper” and “lower”, or “front” and “rear,” are not intended to have absolute orientations but are instead intended to describe relative positions of various components with respect to each other. For example, a first component may be an “upper” component and a second component may be a “lower” component when a device of which the components are a part is oriented in a first direction. The relative orientations of the components may be reversed, or the components may be on the same plane, if the orientation of the structure that contains the components is changed. The claims are intended to include all orientations of a device containing such components.

In this document, when a device is referred to as being located “at” a fluid inlet or “at” a fluid outlet of a system, the device does not necessarily need to be positioned at the precise intake or discharge of the system. Instead, unless the context specifically requires a precise position, the phrase “at the inlet” and similar phrases are intended to mean “at or upstream of the inlet” of a system, while the phrase “at the outlet” and similar phrases are intended to mean “at or upstream of the outlet” of the system.

Additional terms that are relevant to this disclosure are defined at the end of this Detailed Description section.

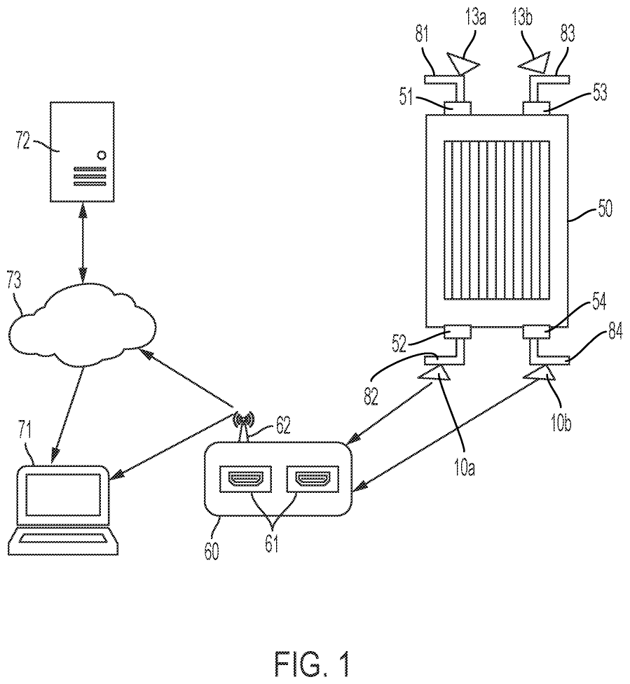

FIG. 1 illustrates elements of an example system for monitoring heat transfer equipment to detect when fouling is reducing the heat transfer capacity of the equipment. The system is used with heat transfer equipment 50. In this illustration heat transfer equipment 50 is a plate heat exchanger that includes a set of plates, with gaps between the plates that form a manifold with multiple passages through which fluid may flow. Plate heat exchangers have numerous applications, including but not limited to heating, ventilation and cooling (HVAC) systems in which the heat exchangers are typically plate-and-frame heat exchangers. However, this disclosure is not limited to plate heat exchanger applications; other types of heat transfer equipment, such as shell and tube heat exchangers that include tubes through which fluid will flow, evaporators, plate evaporation systems, boilers, brazed plate heat exchangers, fusion-bonded plate heat exchangers, gasketed plate-and-frame heat exchangers, print circuit heat exchangers, welded spiral heat exchangers, welded plate-and-block heat exchangers, welded plate-and-shell heat exchangers, scraped surface heat exchangers, tubular heat exchangers, shell-and-tube heat exchangers, tube-in-tube heat exchangers, quench exchangers, process gas boilers, direct contact heat exchangers, refrigeration systems, water heaters, high-temperature, short-time (HTST) and other pasteurization equipment, and waste heat recovery systems may be monitored by the embodiments described in this document. Optionally, the systems and methods described and claimed in this document may be applied to other systems to detect fouling within conduits through which fluid flows in such systems.

The heat transfer equipment 50 includes a first fluid inlet 51 and a first fluid outlet 52 that includes first inlet conduit 81, first outlet conduit 82, and connectors through which a first fluid is received into and transferred out of the system. The heat transfer equipment 50 also includes a second fluid inlet 53 and a second fluid outlet 54 that includes second inlet conduit 83, second outlet conduit 84, and connectors through which a second fluid is received into and transferred out of the system. In some applications, such as pasteurization or other food processing equipment, one of the sides of the heat exchanger is sometimes called a process side as it contains fluid of a temperature that will assist in processing, while the other is sometimes called a product side as it contains the product (such as a beverage or dairy product) being produced. During operation, the temperature of one of two volumes of fluids will increase as it passes from its inlet to its outlet, and the temperature of the other volume of fluid will decrease as it passes from its inlet to its outlet. Each conduit is a pipe, channel, or other fluid-carrying structure that holds and directs fluid into or out of the heat transfer equipment. This document may generally refer to an inlet or an outlet of heat transfer equipment as a “port”, and it will generally refer to any tube, pipe, channel, trough or other passage by which fluid is received into or passed out of a port as a “conduit”.

The system includes one or more sensor devices that are installed directly or indirectly to contact at least one of the conduits that lead to or from a port of the heat transfer equipment. In the example of FIG. 1, the process side conduits of the heat exchanger are on the left side of the heat exchanger 50, while the product-side conduits of the heat exchanger are on the right side of the heat exchanger 50. A process-side outlet sensor device 10a is connected to the first outlet conduit 82 on the process side of the heat exchanger, and a product-side outlet sensor device 10b is connected to the second outlet conduit 84 on the product side of the heat exchanger. A process-side inlet sensor device 13a is connected to the first inlet conduit 81 on the process side of the heat exchanger, and a product-side inlet sensor device 13b is connected to the second inlet conduit 83 on the product side of the heat exchanger. This document may use reference number 10 as a general reference to any such sensor device, including but not limited to sensor devices 10a, 10b, 13a, and 13b shown in FIG. 1.

Each sensor device 10 will include one or more sensors, such as a temperature sensor, and/or an accelerometer, inertial measurement unit, or other type of vibration sensor. Alternatively, if temperature data for the conduit or the fluid is available from another source, the sensor device 10 may not require a temperature sensor.

Each sensor device 10 may include a modem or other communication device that is capable of sending signals to a communication gateway 60. The communication device may be a communication port if the communication gateway 60 is connected to the sensor device 10 by a communication cable, or a transmitter for a wireless configuration). The gateway 60 includes one or more ports 61 or receivers that receive signals from the sensor 10 and: (i) relay the signals via a transmitter 62 to a remote server 72 via a communication network 73; and/or (ii) relay the signals to a local computer 71 via the transmitter 62, either directly or through the communication network 73. The gateway 60 is optional, as the computer 71 may be directly connected to the sensor 10, and if the sensor 10 is equipped with a transmitter then the sensor 10 may transmit signals to the computer 71 and/or remote server 72 either directly or via a communication network 73.

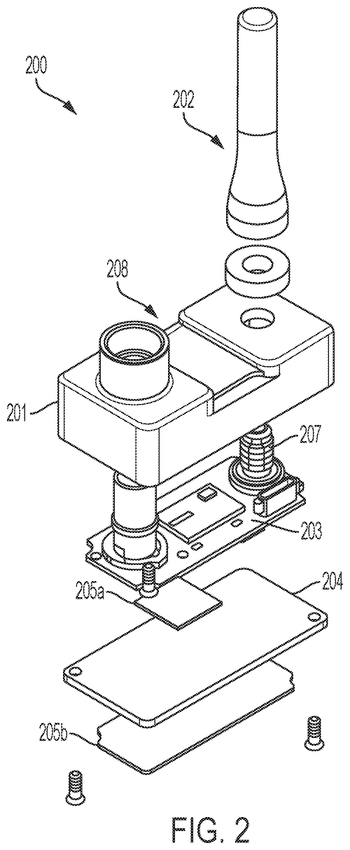

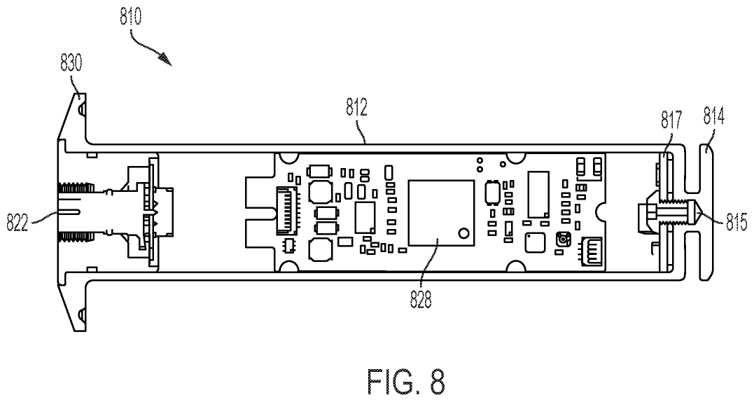

FIG. 2 illustrates a first embodiment of a sensor device 200 in accordance with various embodiments. Another embodiment of a sensor device will be described below in the context of FIG. 8. Referring to the embodiment of FIG. 2, the sensor device 200 includes a housing 201 that holds a circuit board 203 that contains various sensors and other electronics of the system. The housing 201 may be elongated so that its shortest width dimension is not larger than the diameter of the conduit to which the sensor device 200 will be secured. The housing includes a communication device connector 207, which may be a connection port for one or more cables, such as a multi-pin connector terminal or a coaxial cable connection terminal, or alternatively an antenna connection structure to which an antenna 202 may be communicatively connected. The housing 201 includes a channel 208 to receive a securing member, examples of which will be described below. A base plate 204 may be secured to the housing and hold the circuit board 203 and optionally other components within the housing.

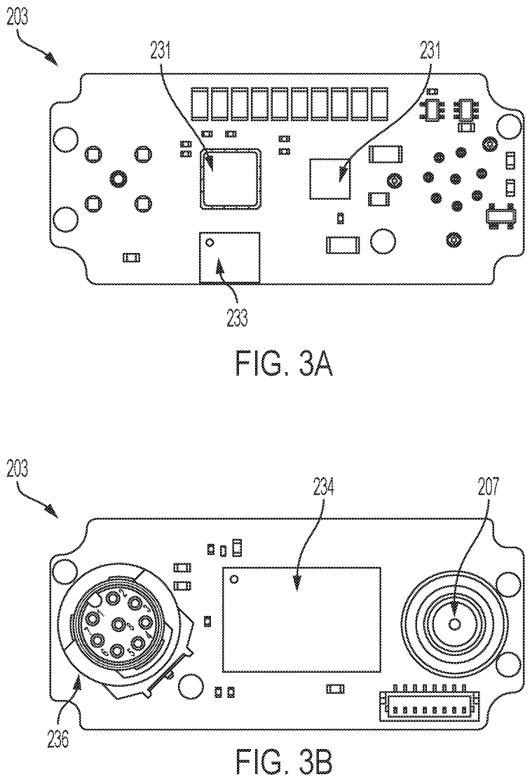

FIGS. 3A and 3B illustrate example electronic components that the circuit board 203 may include. As illustrated in FIG. 3A, which shows a first side surface of the circuit board 203, the electronic components may include a vibration sensor 231 such as an accelerometer. In some embodiments, the vibration sensor 231 may include gyroscope, or it may be an inertial measurement unit (IMU) that includes both an accelerometer and IMU. The circuit board 203 also may include a temperature sensor 232 that is conductively connected to a conduit to which the sensor is attached, or to a conductive probe that contacts or extends within the conduit. Referring to FIG. 2, the conductive connection to the conduit may be provide with one or more conductive layers such as layers of conductive tape, including a first conductive tape layer 205a positioned between the temperature sensor 232 and the base plate 204, and a second conductive tape layer 205b positioned between the temperature sensor base plate 204 and the conduit on which the sensor is placed. The conductive tape layers provide a conductive path to transfer thermal energy from the conduit to the temperature sensor and thus enable the temperature sensor to measure a temperature of the conduit. Other conductive structures and devices may be used.

Referring again to FIG. 3A, the circuit board 203 also may include one or more communication devices 233 such as a subscriber identity module (SIM) card and/or a modem, or another circuit that enables the device to communicate with external systems. As illustrated in FIG. 3B, which shows a second side surface of the circuit board 203 that is opposite the first side, the electronic components may include a processor 234 such as a processor or microcontroller, as well as the communication device connector 207, which in the example shown is an antenna connector. The circuit board 203 also may include a multi-wire connector 236 such as an M8 or M12 connector to lead to a power source to provide power to the device, and also to transfer data from the device to external elements. Optionally, although not shown, the housing 201 may also hold an integral power source.

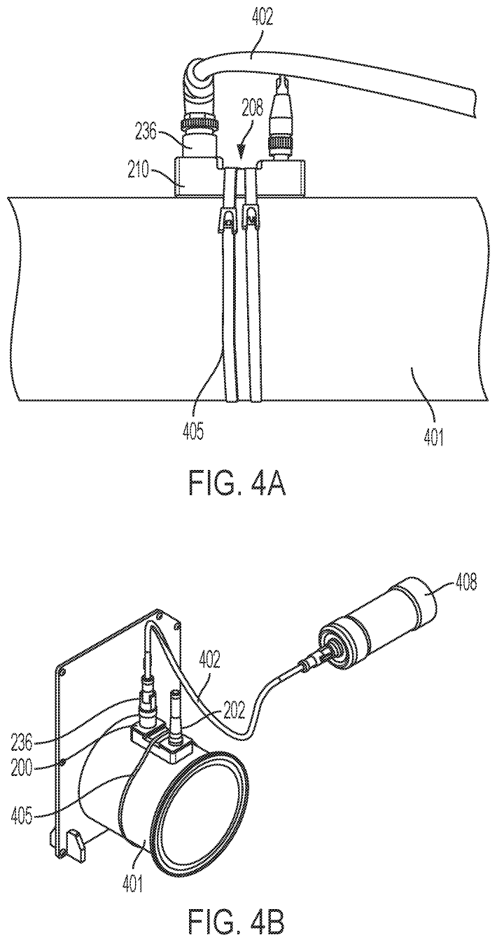

FIGS. 4A and 4B illustrate an example sensor device 200 that is secured to a conduit 401 to measure temperature and/or vibration of the conduit 401. The longest width dimension of the sensor device 200 is positioned along the length of the conduit 401. One or more mounting structures 405 secure the sensor device 200 to the conduit 401. As illustrated, the mounting structures 405 are metal or plastic cable ties, also known as zip ties. The cable ties may be made of flexible metal, plastic, or other material. Other securing members may be used in the mounting structures. In various embodiments, as with the cable ties shown, the mounting structures 405 do not require any penetration into the conduit, and they can be easily attached and removed at various locations along the conduit 401. If the housing 201 of the sensor device includes a channel 208 as shown, the mounting structures may be placed within the channel 208 and wrap around the housing 201 and conduit 401 to prevent the sensor from moving sideways along the pipe. FIGS. 4A and 4B also show an example multi-conductor cable 402 that extends from the multi-wire connector 236 to one or more external devices such as computing devices, a battery or power plug, or another device. As FIG. 4B illustrates, the cable 402 extending from the sensor device 200 to an external power source that is a battery 408.

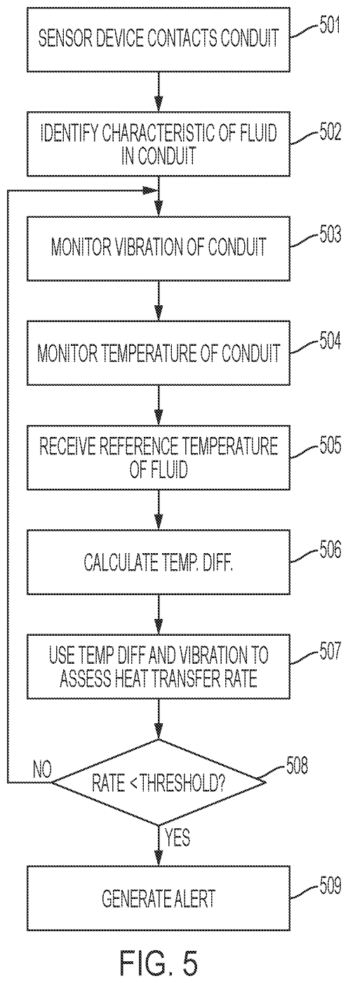

FIG. 5 is a flowchart illustrating a first embodiment of a process by which a system may monitor various characteristics of fluid-carrying equipment to detect fouling or other potential maintenance issues within a fluid flow path of the equipment. In the process, at 501 a sensor device that includes a vibration sensor and a temperature sensor is contacted to a conduit of equipment. The conduit may be one that leads into or out of a port of a heat transfer device, as shown in FIG. 1. Alternatively, the conduit may be within the equipment, and the sensor device may be positioned partially or fully within the equipment. The sensor device may touch the conduit, or it may touch another element of the equipment if that element will exhibit changes in flow-induced vibration and/or temperature in response to fouling or other maintenance issues in the fluid flow path. For the purposes of the discussion below, the term “conduit” will include any such element.

As noted in FIGS. 1 and 2, the system will include one or more processors, such as processors in the sensor device 10, a local computer 71 or a remote server 72. In FIG. 5, at 502 any or all of these processing devices (which this disclosure will generally refer to as a processor) will identify one or more characteristics of the fluid that is passing through the conduit. The characteristics may include a constant such as thermal conductivity K or specific heat capacity cₚ of the fluid. The characteristics also may include other constants such as density p of the fluid. The processor may retrieve the characteristics from a memory, or it may receive the characteristics via a message from another computing device. The processor also may receive the characteristics as a user-entered or user-selected parameter via a user interface of a computing device of which the processor is a part, or to which the processor is communicatively connected, or from which the processor receives messages.

At 503 the sensor device will monitor fluid flow-induced vibration of the conduit and generate a vibration measurement \dot{v} signal that indicates a level of vibration of the conduit. The vibration measurement \dot{v} may be a measurement of vibratory acceleration, a measurement of vibration velocity, or a measurement of displacement, either at a single frequency or over a range of frequencies. Optionally, the sensor device also may measure, or the system may receive from another sensor, one or more frequencies of sound emitted by the conduit, or by other elements of the heat transfer equipment, as fluid passes through the conduit. The frequencies may be measured as the frequency of the flow-induced vibration detected by the vibration sensor, or via other methods.

At 504 the sensor device will monitor temperature of the conduit and generate a temperature signal that indicates temperature of the conduit. At 505 the processor will receive a reference temperature of the fluid. At 506 the processor will calculate the difference ΔT between the monitored temperature and the fluid's reference temperature. The reference temperature will reflect temperature of the fluid at a different location in the fluid path. For example, if the sensor device is connected to an outlet conduit of the fluid path, the reference temperature may reflect the fluid's temperature at or near the inlet port of the fluid path, or vice versa. The reference temperature may be generated by a second temperature sensor positioned at the different location in the fluid path, generated by a temperature sensor connected to storage vessel that is fluidly connected to the different location, retrieved from a memory, or generated in some other way. The temperature difference ΔT will therefore indicate how much the fluid's temperature increased or decreased as the fluid passed through the heat transfer equipment.

At 507 the system will use the temperature difference ΔT and the measured vibration \dot{v} to assess the heat transfer rate within the heat transfer equipment. For example, the system may calculate the heat transfer rate Q of fluid in the system at any point in time as:

Q=ρ\dot{v}cₚΔT, (1)

in which the constant ρ is the fluid's density, and the constant cₚ is the specific heat capacity of the fluid. Other constants that represent various characteristics of the fluid may be used instead of or in addition to these constants. Notably, the system does not use the fluid's flow rate in this calculation, as this calculation does not use flow rate data from a flow meter, and the system does not require a fluid flow meter.

At 508 the system will continue to monitor the conduit's temperature and vibration until the heat transfer rate (or a score or other value that corresponds to the heat transfer rate) drops below a threshold. When this happens (508: YES), the system will generate an alert at 509 to indicate that potential fouling has occurred within the heat transfer equipment. The alert may be an audio, text and/or graphic message, or a signal that causes an external computing device to output such a message, a signal that causes a warning light on the heat transfer equipment to turn on, or some other signal that triggers another device to output an alert.

In embodiments that use multiple sensor devices, the system may generate the alert at 509 when any of the sensor devices detect that a heat transfer rate has dropped below a threshold. Alternatively, the system may generate the alert only if a threshold number of the sensor devices, such as two of the devices or all of the devices, have detected the required drop in heat transfer rate. Alternatively, the system may generate the alert if the absolute value of the difference between the heat transfer rate calculated for one fluid path and the heat transfer rate calculated the second fluid path exceeds a threshold.

Alternatively, the system may use data from multiple sensor devices to generate an assessment of the equipment's heat transfer rate.

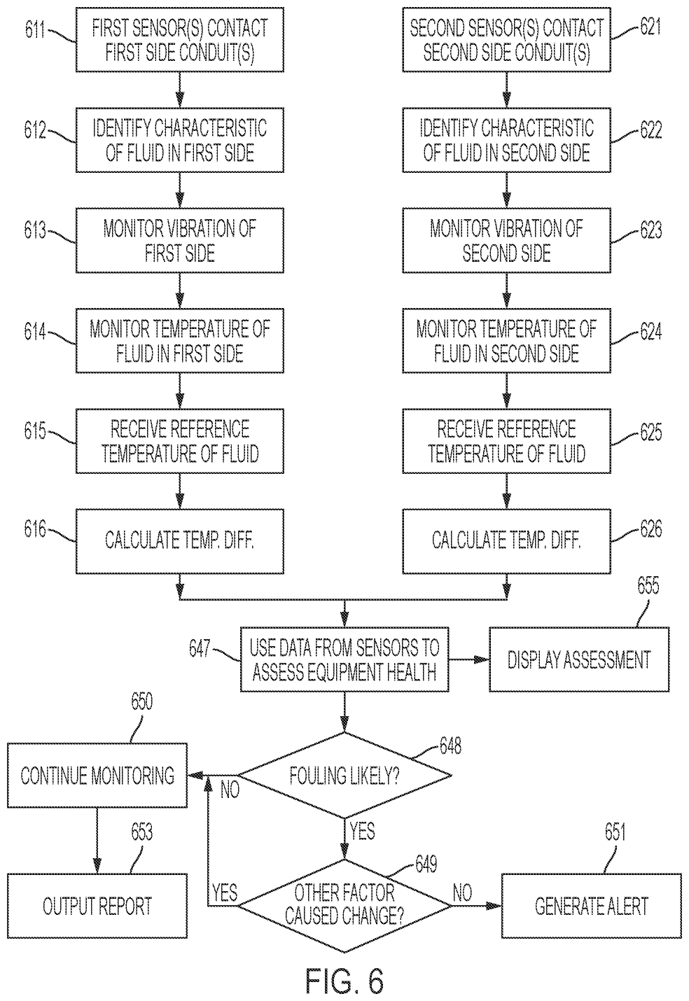

FIG. 6 illustrates an example method by which the system may use data from multiple sensor devices positioned on the process side and the process side of heat transfer equipment to generate an assessment of the equipment's condition.

As with FIG. 5, in FIG. 6 at 611 a first sensor device that includes a vibration sensor and/or temperature sensor is contacted to a conduit of a first side of heat transfer equipment. Optionally, a pair of first sensor devices may be used, one of which is placed on an inlet conduit of the first side, and the other of which is placed on an outlet side conduit, of the heat transfer equipment. (Collectively, this disclosure may refer to the inlet side conduit and outlet side conduit of the first side as the “first conduit”.)

At 612 the system will identify characteristics of the fluid on the first side, such as thermal conductivity K₁, specific heat capacity cₚ₁, and/or density ρ₁ of the first side fluid, using methods such as those described above in FIG. 5.

At 613 each first sensor device will generate a vibration signal that indicates a level of vibration \dot{v}₁ of the first conduit. As with the process of FIG. 5, the vibration measurements captured in FIG. 6 may include measurements of vibratory acceleration, vibration velocity or displacement, either at a single frequency or over a range of frequencies.

At 614 each first sensor device may generate a temperature signal that indicates temperature T₁ of the first conduit. Alternatively, at 614 the system may receive the temperature T₁ from a separate temperature sensor if one is available on or inside of the first conduit. Optionally, in embodiments where a single sensor is used, at 615 the processor may receive a reference temperature of the first fluid. Step 615 may not be required in embodiments where at least two temperature sensors are positioned along the first fluid path, one of which is positioned at the inlet and the other of which is positioned at the outlet of the first side. At 616 the processor will calculate a temperature difference ΔT₁. If a single sensor is used, the temperature difference T₁ will be the difference between the monitored temperature and reference temperature of the first fluid. If multiple sensors are used, the temperature difference ΔT₁ will be the difference between the monitored temperatures at the inlet and at the outlet of the first side.

Concurrently with the process of steps 611-616, at 621 a second sensor device that includes a second vibration sensor and (optionally) a second temperature sensor is contacted to a second conduit on a second side of the heat transfer equipment. Optionally, a pair of second sensor devices may be used, one of which is placed on an inlet conduit of the second side, and the other of which is placed on an outlet conduit of the second side of the heat transfer equipment. (Collectively, this disclosure may refer to the inlet side conduit and outlet side conduit of the second side as the “second conduit”.) The first conduit will be in a first fluid path (such as a process side) of the heat transfer equipment, while the second conduit will be in a second fluid path (such as a product side) of the heat transfer equipment. The two fluid paths may carry the same type of fluid, or different types of fluids, through them.

At 622 the system will identify characteristics of the second side fluid, such as thermal conductivity K₂, specific heat capacity cₚ₂, and/or density ρ₂ of the second side fluid, using methods such as those described above in FIG. 5.

At 623 each second sensor device will generate a vibration signal that indicates a level of vibration \dot{v}2 of the second conduit. Example types of vibration signals have been described above.

At 624 each second sensor device may generate a temperature signal that indicates temperature T₂ of the second conduit. Alternatively, at 624 the system may receive the temperature T₂ from a separate sensor, if available on or inside of the first conduit. Optionally, in embodiments where a single sensor is used, at 625 the processor may receive a reference temperature of the second fluid. Step 625 may not be required in embodiments where at least two temperature sensors are positioned along the second fluid path, one of which is positioned at the inlet and the other of which is positioned at the outlet of the second side. At 626 the processor will calculate a temperature difference ΔT₂. If a single sensor is used, the temperature difference ΔT₂ will be the difference between the monitored temperature and reference temperature of the second fluid. If multiple sensors are used, the temperature difference ΔT₂ will be the difference between the monitored temperatures at the inlet and at the outlet of the second side.

At 647, the system may use the data listed above to assess heat transfer rates on each side of the equipment and identify changes in the rates over time. The changes monitored may include a change in the heat transfer rate on one side of the system over time, and/or a change in differences the between the first and second sides' heat transfer rates over time. In this way, the system may assess whether fouling is likely occurring in the heat transfer equipment at 647 using an algorithm such as one that determines whether:

ρ₁\dot{v}₁cₚ₁ΔT₁=ρ₂\dot{v}₂cₚ₂ΔT₂. (2)

Optionally, when assessing the heat transfer rate for each side, the system also may apply a fouling factor μ to each side of the equation above, and it may monitor the system for changes in the fouling factor at any point in time. In this situation, the algorithm may change to:

(ρ₁\dot{v}₁cₚ₁ΔT₁)*μ_{1,2}=(ρ₂\dot{v}₂cₚ₂ΔT₂)*μ_{2,1}, (3)

in which μ_{1,2} is a fouling factor representing heat transfer from fluid volume 1 (on the first side of the heat transfer equipment) to fluid volume 2 (on the second side of the heat transfer equipment), and in which μ_{2,1} is a fouling factor representing heat transfer from fluid volume 2 to fluid volume 1.

If the result of equation (2) or equation (3) above is true (or substantially true, within a tolerance range such as one that allows for differences of no more than 1%, 10%, or any number between those two values), then the system may simply continue monitoring the equipment at 650. If the equation above is not true (optionally allowing for a tolerance range as noted above), then the system may generate an alert at 649 indicating that fouling has likely occurred in at least one of the fluid paths. Optionally, at 653 the system may continue to monitor the equipment and output one or more reports that operators or other systems may use to detect significant process changes that are indicative of fouling.

If (a) the first fluid and the second fluid are not the same type, or (b) if the total volumes or other characteristics of the fluid paths differ from each other, then instead of equality the system may a determine a difference D between the heat transfer rates of the first and second fluid flow paths, such as in the following equation:

D=ρ₁\dot{v}₁cₚ₁ΔT₁−ρ₂\dot{v}₂cₚ₂ΔT₂ (4)

If the equipment is not affected by fouling, then the difference D should remain constant over time (648: NO), and the system will simply continue to monitor the equipment at 650. However, if the difference changes over by more than a threshold amount in a time period or if another monitored value or function of the values indicates that fouling is likely (648: YES), then the system may generate an alert at 651 indicating that fouling has likely occurred in at least one of the fluid paths. In the equation above, the inclusion of heat capacities cₚ₁ and cₚ₂ in the equation is optional, since those are constants that will not change over time and thus are not needed to calculate the difference D.

In some embodiments, the alert may trigger an automatic cleaning mode in the equipment, if the equipment is configured to have such a mode. Example automatic cleaning modes include a clean-in-place process in which a cleaning solution is passed through either or both sides of the system. Optionally, the system may require a clean-in-place process to be performed, either once or optionally twice, before the monitoring will re-start. Alternatively, the alert may simply appear in a report, in which case maintenance personnel will know to perform maintenance. The system may then restart the monitoring process of FIG. 6 at a new start time t_{zero}.

Optionally, when assessing the equipment's health at 647 the system may use the difference D to generate a value representing a score the equipment's assessed potential for fouling. The value may simply be a number that corresponds to an inverse of the value of D (that is, a lower D will yield a higher score). In other embodiments, the system may calculate the value as a function of the difference D over time, or as a function of a change in the measured vibratory levels of either or both fluid flow paths over time. The system may cause a user interface of a computing device to output a representation of the assessment at 655, such as by displaying the numeric value on a display, or by outputting a visual indication of the value such as a bar, a gauge or another visual indicator that changes as the value changes. In addition, the system may use the value to determine that fouling is likely (648: YES) when the value falls below a threshold.

Optionally, the system may measure other parameters of the heat transfer equipment, and/or consider other data from other sources, and factor the other parameters or data in the calculations. If the other parameters or data indicate that another factor likely caused the detected change (649: YES), then the system may simply continue monitoring and not generate the alert. For example, as noted above, the system may also use the vibration sensor or other sensors to measure the frequency of the vibrations. If the frequency of the vibration suddenly changes and the time of the change correlates to a time at which an external event was likely to cause the change, the system may be programmed to not generate an alert if the external event likely caused the change. Example events may be a pump turning on or off, or a manual change of the system to a cleaning or maintenance mode. However, if no such other factor was detected (649: NO), or if the system is not programmed to consider such other factors, then the system may generate the alert when a threshold change is detected (649: YES).

To assess how the system may determine a fouling factor μ, consider that when one looks at the relationships with respect to time, equation (3) becomes:

(ρ(t)v(t)cₚ(t)ΔT(t))₁*μ(t)₁₂=(ρ(t)cₚ(t)ΔT(t))₂*μ(t)₂₁ (5)

Rearranging equation (5) to get the fouling factor terms on one side:

$$\frac{{μ ( t )}_{12}}{{μ ( t )}_{21}} = \frac{{( ρ ( t ) ν \dot{(} t ) {c}_{p} ( t ) Δ T ( t ) )}_{2}}{{( ρ ( t ) ν \dot{(} t ) {c}_{p} ( t ) Δ T ( t ) )}_{1}} \qquad ( 6 )$$

The system may consider an additional variable to represent fouling factor ratio, η:

$$η ( t ) = \frac{{μ ( t )}_{12}}{{μ ( t )}_{21}} \qquad ( 7 )$$

and if so, the system may monitor the equipment for changes in the fouling factor ratio over time. If the fouling factor changes by a certain amount (such as 10%, or 20%) as compared to a reference number, such as the first fouling factor calculated from monitoring data taken after the equipment last had repairs or preventative maintenance performed on it.

To do this, optionally the system may take a derivative of η, η′. For example, the system may calculate logarithms of both sides of equation (7):

$$ln ( η ) = ln ( \frac{{( ρ ( t ) ν \dot{(} t ) {c}_{p} ( t ) Δ T ( t ) )}_{2}}{{( ρ ( t ) ν \dot{(} t ) {c}_{p} ( t ) Δ T ( t ) )}_{1}} ) \qquad ( 8 )$$

one may expand the right side of equation (8) as follows:

ln(η(t))=ln(p(t)₂)+ln(v{dot over (()}t)₂)+ln(cₚ(t)₂)+ln(ΔT(t)₂)−ln(ρ(t)₁)+ln(v{dot over (()}t)₁)+ln(cₚ(t)₁)+ln(ΔT(t)₁) (9)

and one can take the derivative:

$$\frac{{( η ( t ) )}^{′}}{( η ( t ) )} = \frac{{( {ρ ( t )}_{2} )}^{′}}{( {ρ ( t )}_{2} )} + \frac{{{( ν \dot{(} t )}_{2} )}^{′}}{{( ν \dot{(} t )}_{2} )} + \frac{{( {{c}_{p} ( t )}_{2} )}^{′}}{( {{c}_{p} ( t )}_{2} )} + \frac{{( Δ {T ( t )}_{2} )}^{′}}{( Δ {T ( t )}_{2} )} - \frac{{( {ρ ( t )}_{1} )}^{′}}{( {ρ ( t )}_{1} )} - \frac{{{( ν \dot{(} t )}_{1} )}^{′}}{{( ν \dot{(} t )}_{1} )} - \frac{{( {{c}_{p} ( t )}_{1} )}^{′}}{( {{c}_{p} ( t )}_{1} )} - \frac{{( Δ {T ( t )}_{1} )}^{′}}{( Δ {T ( t )}_{1} )} \qquad ( 10 )$$

If one assumes that the characteristics of the fluid volumes on both sides of the system will be constant over some time t, the equation reduces to the following:

$$\frac{{( η ( t ) )}^{′}}{( η ( t ) )} = \frac{{{( ν \dot{(} t )}_{2} )}^{′}}{{( ν \dot{(} t )}_{2} )} + \frac{{( Δ {T ( t )}_{2} )}^{′}}{( Δ {T ( t )}_{2} )} - \frac{{{( ν \dot{(} t )}_{1} )}^{′}}{{( ν \dot{(} t )}_{1} )} - \frac{{( Δ {T ( t )}_{1} )}^{′}}{( Δ {T ( t )}_{1} )} \qquad ( 11 )$$

In systems that monitor heat exchangers, there may be a target ΔT(t) to be achieved for either the fluid on the first side or the fluid on the second side as the fluid passes through the system. A control system may be used to vary v{dot over (()}t)₂, ΔT(t)₂, and v{dot over (()}t)₁ to keep ΔT(t)₁ constant over time. For this example, we assume that ΔT(t)₁ will remain constant.

After multiplying equation (11) by η(t), the change in the fouling factor ratio becomes:

$${( η ( t ) )}^{′} = ( η ( t ) ) ( \frac{{{( ν \dot{(} t )}_{2} )}^{′}}{{( ν \dot{(} t )}_{2} )} + \frac{{( Δ {T ( t )}_{2} )}^{′}}{( Δ {T ( t )}_{2} )} - \frac{{{( ν \dot{(} t )}_{1} )}^{′}}{{( ν \dot{(} t )}_{1} )} ) \qquad ( 12 )$$

In all of the above, temperature sensors such as those described above may be used to measure ΔT(t)₁′ and ΔT(t)₂′ at each time t. Accelerometers or IMUs in the sensors may be used to measure pump or other equipment characteristics that propagate through the fluid to surface that results in (v{dot over (()}t)₂)′ and (v{dot over (()}t)₁)′ at time t.

In addition, in any of the calculations above, the system may apply an averaging filter to produce (TKO), ΔT(t)₁, ΔT(t)₂, (v{dot over (()}t)₂) and (v{dot over (()}t)₁) at time t.

Notably, in the processes above, the system need not directly measure the flow rate of any fluid passing through the heat transfer equipment. Thus, the system does not need, and the assessment may be performed without reference to data from, any fluid flow rate meters.

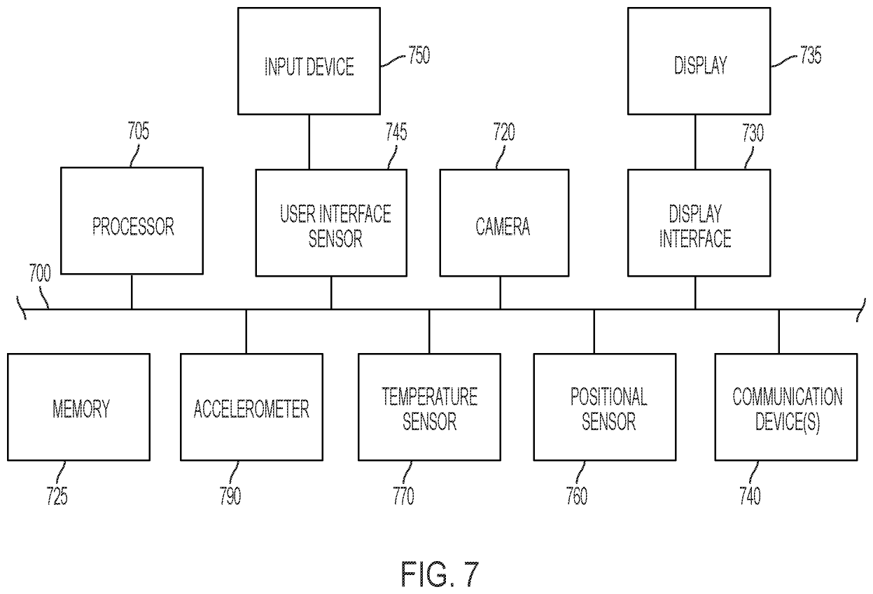

FIG. 7 depicts an example of internal hardware that may be included in any of the electronic components of the system, such as the onboard hardware of the sensor 10 of FIG. 1, or that of the computing device 71 or server 72 of FIG. 1. An electrical bus 700 serves as an information highway interconnecting the other illustrated components of the hardware. Processor 705 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 525. A memory device may include a single device or a collection of devices across which data and/or instructions are stored.

An optional display interface 730 may permit information from the bus 700 to be displayed on a display device 735 in visual, graphic or alphanumeric format. An audio interface and audio output (such as a speaker) also may be provided. Communication with external devices may occur using various communication devices 740 such as a wireless antenna, an RFID tag and/or short-range or near-field communication transceiver, each of which may optionally communicatively connect with other components of the device via one or more communication system. The communication device 740 may be configured to be communicatively connected to a communications network, such as the Internet, a local area network or a cellular telephone data network.

The hardware may also include a user interface sensor 745 that allows for receipt of data from input devices 750 such as a keyboard, a mouse, a joystick, a touchscreen, a touch pad, a remote control, a pointing device and/or microphone. Digital image frames also may be received from a camera 720 that can capture video and/or still images. The system also may include a positional sensor 780 such as a global positioning system (GPS) sensor device that receives positional data from an external GPS network. Various elements of the system (as installed in the sensor) also may include a temperature sensor 780 and an accelerometer 790 or other vibration sensor, as previously described in the context of FIG. 2 above.

FIG. 8 illustrates a cut-away view of an example of a second embodiment of a sensor device 810 in accordance with various embodiments. Sensor device 810 includes a housing 812, which may have a first end that is connected to a fitting 830. The housing 812 may be cylindrical, or it may be shaped in another form such as a rectangular or conical shape, and formed of any appropriate protective material such as stainless steel. The fitting 830 may be designed to connect the sensor to another device that secures the sensor in position. Fitting 830 is optional and may not be required.

A second end of the housing 812 includes a pad 814 that, during operation, is positioned to contact an outer surface of a conduit leading to a port of the heat transfer equipment. The pad 814 may be a flat circle, rectangle, oval, square, or other shape. The pad 814 is electrically connected to a vibration sensor 815, such as an accelerometer, IMU, or other transducer, that will convert the pad's vibrations to electrical signals. The pad 814 also be electrically connected to a temperature sensor 817 that can measure the temperature of the conduit that the pad member 814 contacts. The outputs of the temperature sensor 817 and vibration sensor 815 are electrically connected to an onboard processor 828. The processor 828 may be a microprocessor that will execute programming instructions stored on a memory 829, or it may be an element of a microcontroller that includes a memory with programming instructions. The processor 828 will receive the signals from the temperature sensor 817 and vibration sensor 815 and use those signals to assign values to the temperature, vibration and other parameters associated with the conduit to which the sensor is attached.

The processor 828 may transfer the measured data via a communication port 822 to an external processor (such as that of the computer 71 in FIG. 1) for supplemental processing and data visualization. The communication port 822 shown is a High-Definition Multimedia Interface (HDMI) port, but any connection for communicating measurements to an outboard analysis unit may be used.

In some alternative embodiments, instead of determining the temperature and the vibration measurements onboard the sensor 810, the sensor 810 may simply transfer data received from the temperature sensor 817 and vibration sensor 815 to an off-board computing device to perform the determination outside of the sensor device 810.

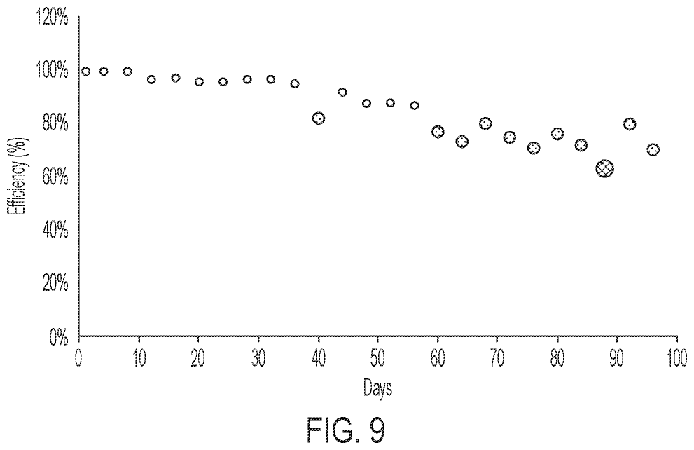

FIG. 9 illustrates an example report that the systems and methods described above may generate, showing efficiency of a heat exchanger dropping over time. The report may be printed, displayed on a screen, or transmitted as an electronic document file. As shown, the system may alert a user to a drop in efficiency of 20% (i.e., from approximately 100% to 80% efficiency) by representing the days in which data shows the efficiency drop a different appearance, such as a first different color or size. Further reductions in efficiency, such as a reduction to 70% efficiency, may be displayed in a second different color or size.

In this document, the terms “electronic device,” “computer” and “computing device” refer to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, digital home assistants and mobile electronic devices such as smartphones, fitness tracking devices, wearable virtual reality devices, Internet-connected wearables such as smart watches and smart eyewear, personal digital assistants, cameras, tablet computers, laptop computers, media players and the like. Electronic devices also may include appliances and other devices that can communicate in an Internet-of-things arrangement. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity. Additional elements that may be included in electronic devices are discussed above in the context of FIG. 7.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link.

“Electronic communication” refers to the transmission of data via one or more signals between two or more electronic devices, whether through a wired or wireless network, and whether directly or indirectly via one or more intermediary devices. Devices are “electronically connected” if a path for transmission of electronic signals exists between the two devices.

In this document, the term “connected,” when referring to two physical structures and not used in the context of electronic or communicative connection, means that the two physical structures touch each other. Devices that are connected may be secured to each other, or they may simply touch each other and not be secured.

In this document, the term “fluid” has its common meaning as any substance that has no fixed shape and yields easily to external pressure. A fluid may be a liquid, a gas or a plasma. In addition, a fluid may contain some solids so long as the overall substance will flow in response to the application of force.

As described above, this disclosure describes various embodiments of methods and systems for monitoring a fluid flow path of heat transfer equipment. The embodiments include, without limitation, those described in the following examples:

Example 1: A system for monitoring a fluid flow path of heat transfer equipment, the system comprising: (i) a first sensor device that comprises a first vibration sensor and a first temperature sensor; and (ii) a memory containing programming instructions that are configured to cause a processor to, when the first sensor device is connected to a first conduit of the heat transfer equipment: (a) receive, from the first sensor device, a first temperature signal that is indicative of temperature of the first conduit, and a first vibration signal that is indicative of vibration of the first conduit; (b) use the first temperature signal and the first vibration signal to assess a heat transfer rate of the heat transfer equipment; and (c) generate a report of the heat transfer rate over time.

Example 2: The system of example 1, wherein the programming instructions are configured to, in response to detecting that a reduction in the heat transfer rate of the heat transfer equipment has occurred over a time period, include in the report an alert of potential fouling in the heat transfer equipment.

Example 3: The system of example 1 or 2, wherein the instructions to use the first temperature signal and the first vibration signal to assess the heat transfer rate of the heat transfer equipment comprise instructions to: (i) using (a) a reference temperature of a first fluid that is in a flow path that includes the first conduit and (b) the first temperature signal, determine a temperature change that the first fluid exhibited while passing through the flow path; and (ii) use a first constant that represents a characteristic of the first fluid, the first vibration signal, and the temperature change to calculate the heat transfer rate.

Example 4: The system of example 3, further comprising: (i) a second sensor device that comprises a second vibration sensor and a second temperature sensor; and (ii) programming instructions that are configured to cause the processor to, when the second sensor device is connected to a second conduit of the heat transfer equipment: (a) upon receiving, from the second sensor device, a second temperature signal that is indicative of temperature of the second conduit and a second vibration signal that is indicative of vibration of the second conduit; also use the second temperature signal and the second vibration signal when assessing the heat transfer rate of the heat transfer equipment.

Example 5: The system of example 4, wherein the instructions to use the first and second temperature signals and the first and second vibration signals to assess the heat transfer rate of the heat transfer equipment comprise instructions to: (i) determine a first temperature change of a first fluid while passing through a first flow path of the heat transfer equipment; (ii) determine a second temperature change of a second fluid while passing through a second flow path of the heat transfer equipment; and (iii) use a first constant that represents a characteristic of the first fluid, a second constant that represents a characteristic of the second fluid, the first vibration signal, the second vibration signal, the first temperature change of the first fluid, and the second temperature change of the second fluid to assess the first heat transfer rate.

Example 6: The system of example 5, wherein: (i) the instructions to use the first constant, the second constant, the first vibration signal, the second vibration signal, the temperature change of the first fluid, and the temperature rate of the second fluid to assess of the heat transfer rate comprises comparing a measured characteristic of the first flow path to a measured characteristic of the second flow path; and (ii) the programming instructions further comprise instructions to determine that that a reduction in the heat transfer rate of the heat transfer equipment may have occurred over the time period responsive to determining, via the comparing, that a relative difference between the measured characteristic of the first path and the measured characteristic of the second flow path has changed more than a threshold amount over the time period.

Example 7: A method of monitoring a fluid flow path of heat transfer equipment, the method comprising: (i) contacting, to a first conduit of the heat transfer equipment, a first sensor device that comprises a first vibration sensor and a first temperature sensor; (ii) receiving, from the first sensor device, a first temperature signal that is indicative of temperature of the first conduit, and a first vibration signal that is indicative of vibration of the first conduit; (iii) using the first temperature signal and the first vibration signal to assess a heat transfer rate of the heat transfer equipment; and (iv) generating a report of the heat transfer rate over time.

Example 8: The method of example 7, further comprising, in response to detecting that a reduction in the heat transfer rate of the heat transfer equipment has occurred over a time period, including in the report an alert of potential fouling in the heat transfer equipment.

Example 9: The method of example 7 or 8, wherein using the first temperature signal and the first vibration signal to assess the heat transfer rate of the heat transfer equipment comprises: (i) using (a) a reference temperature of a first fluid that is in a flow path that includes the first conduit and (b) the first temperature signal, determining a temperature change that the first fluid exhibited while passing through the flow path; and (ii) using a first constant that represents a characteristic of the first fluid, the first vibration signal, and the temperature change to calculate the heat transfer rate.

Example 10: The method of any of examples claim 7-9, further comprising: (i) contacting, to a second conduit of the heat transfer equipment, a second sensor device that comprises a second vibration sensor and a second temperature sensor, wherein the first conduit is of a first or process side of the heat transfer equipment and the second conduit is of a second or product side of the heat transfer equipment; (ii) receiving, from the second sensor device, a second temperature signal that is indicative of temperature of the second conduit, and also a second vibration signal that is indicative of vibration of the second conduit; and (iii) also using the second temperature signal and the second vibration signal when assessing the heat transfer rate of the heat transfer equipment.

Example 11: The method of example 10, wherein using the first and second temperature signals and the first and second vibration signals to assess the heat transfer rate of the heat transfer equipment comprises: (i) determining a first temperature change of a first fluid while passing through a first flow path of the heat transfer equipment; (ii) determining a second temperature change of a second fluid while passing through a second flow path of the heat transfer equipment; and (iii) using a first constant that represents a characteristic of the first fluid, a second constant that represents a characteristic of the second fluid, the first vibration signal, the second vibration signal, the first temperature change of the first fluid, and the second temperature change of the second fluid to assess the heat transfer rate.

Example 12: The method of example 11, wherein: using the first constant, the second constant, the first vibration signal, the second vibration signal, the first temperature change of the first fluid, and the temperature change of the second fluid to assess of the heat transfer rate comprises comparing a measured characteristic of the first flow path to a measured characteristic of the second flow path; and the method further comprises determining that a reduction in the heat transfer rate of the heat transfer equipment may have occurred over the time period responsive to determining, via the comparing, that a relative difference between the measured characteristic of the first flow path and the measured characteristic of the second flow path has changed more than a threshold amount over the time period.

Example 13: A system for monitoring heat transfer equipment, the system comprising one or more sensing devices, each of which comprises a housing containing (a) a circuit board containing a vibration sensor and a temperature sensor, and (b) a connector configured to receive power from a power source. The system also includes a communication device, and a base containing a conductive layer that is conductively connected to the temperature sensor. The conductive layer is positioned to provide a conductive path from the temperature sensor to a conduit on which the base is placed and thus enable the temperature sensor to sense temperature of the system.

Example 14: The system of example 13, wherein the housing comprises a channel on a side of the housing that is opposite the base, and the system further comprises a mounting structure that is configured to pass through the channel and wrap around the conduit without penetrating the conduit.

Example 15: The system of example 14, wherein the mounting structure comprises a cable tie.

Example 16: The system of any of examples 13-15, wherein the one or more sensing devices comprise: (i) a first sensing device positioned at an inlet of a first or process side of the heat transfer equipment; (ii) a second sensing device positioned at an outlet of the first or process side of the heat transfer equipment; (iii) a third sensing device positioned at an inlet of a second or product side of the heat transfer equipment; and (iv) a fourth sensing device positioned at an outlet of the second or product side of the heat transfer equipment.

Example 17: The system of example 16, further comprising a computing device comprising a processor and programming instructions that are configured to, upon receipt of receive vibration signals and temperature signals of each of the sensing devices: (i) use the vibration signals and the temperature signals to assess a heat transfer rate of the heat transfer equipment; and (ii) generate a report of the heat transfer rate over time.

The features and functions described above, as well as alternatives, may be combined into many other different systems or applications. Various alternatives, modifications, variations or improvements may be made by those skilled in the art, each of which is also intended to be encompassed by the disclosed embodiments.

1. A system for monitoring a fluid flow path of heat transfer equipment, the system comprising:
a first sensor device that comprises a first vibration sensor and a first temperature sensor; and
a memory containing programming instructions that are configured to cause a processor to, when the first sensor device is connected to a first conduit of the heat transfer equipment:
receive, from the first sensor device:
a first temperature signal that is indicative of temperature of the first conduit, and
a first vibration signal that is indicative of vibration of the first conduit;
use the first temperature signal and the first vibration signal to assess a heat transfer rate of the heat transfer equipment; and
generate a report of the heat transfer rate over time.

2. The system of claim 1, wherein the programming instructions are configured to, in response to detecting that a reduction in the heat transfer rate of the heat transfer equipment has occurred over a time period, include in the report an alert of potential fouling in the heat transfer equipment.

3. The system of claim 1, wherein the instructions to use the first temperature signal and the first vibration signal to assess the heat transfer rate of the heat transfer equipment comprise instructions to:
using (a) a reference temperature of a first fluid that is in a flow path that includes the first conduit and (b) the first temperature signal, determine a temperature change that the first fluid exhibited while passing through the flow path; and
use a first constant that represents a characteristic of the first fluid, the first vibration signal, and the temperature change to calculate the heat transfer rate.

4. The system of claim 3, further comprising:
a second sensor device that comprises a second vibration sensor and a second temperature sensor; and
programming instructions that are configured to cause the processor to, when the second sensor device is connected to a second conduit of the heat transfer equipment:
upon receiving, from the second sensor device:
a second temperature signal that is indicative of temperature of the second conduit, and
a second vibration signal that is indicative of vibration of the second conduit,
also use the second temperature signal and the second vibration signal when assessing the heat transfer rate of the heat transfer equipment.

5. The system of claim 4, wherein the instructions to use the first and second temperature signals and the first and second vibration signals to assess the heat transfer rate of the heat transfer equipment comprise instructions to:
determine a first temperature change of a first fluid while passing through a first flow path of the heat transfer equipment;
determine a second temperature change of a second fluid while passing through a second flow path of the heat transfer equipment; and
use a first constant that represents a characteristic of the first fluid, a second constant that represents a characteristic of the second fluid, the first vibration signal, the second vibration signal, the first temperature change of the first fluid, and the second temperature change of the second fluid to assess the first heat transfer rate.

6. The system of claim 5, wherein:
the instructions to use the first constant, the second constant, the first vibration signal, the second vibration signal, the temperature change of the first fluid, and the temperature rate of the second fluid to assess of the heat transfer rate comprises comparing a measured characteristic of the first flow path to a measured characteristic of the second flow path; and
the programming instructions further comprise instructions to determine that that a reduction in the heat transfer rate of the heat transfer equipment may have occurred over the time period responsive to determining, via the comparing, that a relative difference between the measured characteristic of the first path and the measured characteristic of the second flow path has changed more than a threshold amount over the time period.

7. A method of monitoring a fluid flow path of heat transfer equipment, the method comprising:
contacting, to a first conduit of the heat transfer equipment, a first sensor device that comprises a first vibration sensor and a first temperature sensor;
receiving, from the first sensor device:
a first temperature signal that is indicative of temperature of the first conduit, and
a first vibration signal that is indicative of vibration of the first conduit; and
using the first temperature signal and the first vibration signal to assess a heat transfer rate of the heat transfer equipment; and
generating a report of the heat transfer rate over time.

8. The method of claim 7, further comprising, in response to detecting that a reduction in the heat transfer rate of the heat transfer equipment has occurred over a time period, including in the report an alert of potential fouling in the heat transfer equipment.

9. The method of claim 7, wherein using the first temperature signal and the first vibration signal to assess the heat transfer rate of the heat transfer equipment comprises:
using (a) a reference temperature of a first fluid that is in a flow path that includes the first conduit and (b) the first temperature signal to determine a temperature change that the first fluid exhibited while passing through the flow path; and
using a first constant that represents a characteristic of the first fluid, the first vibration signal, and the temperature change to calculate the heat transfer rate.

10. The method of claim 7, further comprising:
contacting, to a second conduit of the heat transfer equipment, a second sensor device that comprises a second vibration sensor and a second temperature sensor, wherein the first conduit is of a first or process side of the heat transfer equipment and the second conduit is of a second or product side of the heat transfer equipment;
receiving, from the second sensor device:
a second temperature signal that is indicative of temperature of the second conduit, and
a second vibration signal that is indicative of vibration of the second conduit; and
also using the second temperature signal and the second vibration signal when assessing the heat transfer rate of the heat transfer equipment.

11. The method of claim 10, wherein using the first and second temperature signals and the first and second vibration signals to assess the heat transfer rate of the heat transfer equipment comprises:
determining a first temperature change of a first fluid while passing through a first flow path of the heat transfer equipment;
determining a second temperature change of a second fluid while passing through a second flow path of the heat transfer equipment; and
using a first constant that represents a characteristic of the first fluid, a second constant that represents a characteristic of the second fluid, the first vibration signal, the second vibration signal, the first temperature change of the first fluid, and the second temperature change of the second fluid to assess the heat transfer rate.

12. The method of claim 11, wherein:
using the first constant, the second constant, the first vibration signal, the second vibration signal, the first temperature change of the first fluid, and the temperature change of the second fluid to assess of the heat transfer rate comprises comparing a measured characteristic of the first flow path to a measured characteristic of the second flow path; and
the method further comprises determining that a reduction in the heat transfer rate of the heat transfer equipment may have occurred over the time period responsive to determining, via the comparing, that a relative difference between the measured characteristic of the first flow path and the measured characteristic of the second flow path has changed more than a threshold amount over the time period.

13. A system for monitoring heat transfer equipment, the system comprising:
one or more sensing devices, each of which comprises a housing containing:
a circuit board containing a vibration sensor and a temperature sensor,
a connector configured to receive power from a power source;
a communication device; and
a base containing a conductive layer that is conductively connected to the temperature sensor,
wherein the conductive layer is positioned to provide a conductive path from the temperature sensor to a conduit on which the base is placed and thus enable the temperature sensor to sense temperature of the system.

14. The system of claim 13, wherein:
the housing comprises a channel on a side of the housing that is opposite the base; and
the system further comprises a mounting structure that is configured to pass through the channel and wrap around the conduit without penetrating the conduit.

15. The system of claim 14, wherein the mounting structure comprises a cable tie.

16. The system of claim 13, wherein the one or more sensing devices comprise:
a first sensing device positioned at an inlet of a first or process side of the heat transfer equipment;
a second sensing device positioned at an outlet of the first or process side of the heat transfer equipment;
a third sensing device positioned at an inlet of a second or product side of the heat transfer equipment; and
a fourth sensing device positioned at an outlet of the second or product side of the heat transfer equipment.

17. The system of claim 16, further comprising a computing device comprising a processor and programming instructions that are configured to, upon receipt of receive vibration signals and temperature signals of each of the sensing devices:
use the vibration signals and the temperature signals to assess a heat transfer rate of the heat transfer equipment; and
generate a report of the heat transfer rate over time.
